(19) United States
(12) Patent Application Publication
(10) Pub. No.: US 2021/0172578 A1
(43) Pub. Date: Jun. 10, 2021

(54) VEHICLE LAMP

(71) Applicant: KOITO MANUFACTURING CO., LTD, Tokyo (JP)

(72) Inventor: Masanori KITO, Shizuoka-shi (JP)

(73) Assignee: KOITO MANUFACTURING CO., LTD., Tokyo (JP)

(21) Appl. No.: 16/759,145

(22) PCT Filed: Oct. 12, 2018
(86) PCT No.: PCT/JP2018/038153

§ 371 Date: Apr. 24, 2020

(30) Foreign Application Priority Data
Oct. 26, 2017 (JP) 2017-206887

(51) Int. Cl. F21S 41/40; F21S 41/176; F21S 41/25

(52) U.S. Cl. CPC F21S 41/40; F21S 45/47; F21S 41/25; F21S 41/176

(57) ABSTRACT

A vehicle lamp (1) includes: a light source (51) that emits light of a predetermined wavelength; a diffractive optical element (53) that diffracts light emitted from the light source (51) into a predetermined light distribution pattern; a wavelength conversion element (55) in which the light distribution pattern is projected, and that widens a wavelength band of incident light and emits the light; and a projection lens (56) that projects the light distribution pattern projected on the wavelength conversion element (55).

### TECHNICAL FIELD

The present invention relates to a vehicle lamp, and more specifically, to a vehicle lamp that can be downsized and in which color blur is suppressed.

### BACKGROUND ART

Examples of the vehicle lamp include a vehicle headlamp typified by a headlight for an automobile. The vehicle headlamp is configured to apply at least a low beam for illuminating the front at night. In order to form a light distribution pattern of the low beam, a shade that blocks some of light emitted from a light source is used. However, with the diversification of vehicle designs, there is a demand for downsizing of vehicle headlamps.

Patent Literature 1 below describes a vehicle headlamp that can form a light distribution pattern of a low beam without using a shade. The vehicle headlamp includes a hologram element and a light source that applies reference light to the hologram element. The hologram element is calculated such that diffracted light reproduced by applying the reference light forms a light distribution pattern of a low beam. Since the vehicle headlamp forms a light distribution pattern of a low beam by the hologram element in this way, the vehicle headlamp does not require a shade and can be downsized.
[Patent Literature 1] JP2012-146621 A

### SUMMARY OF INVENTION

White reference light is incident from a light source on the hologram element of the vehicle headlamp in above Patent Literature 1, and a light distribution pattern of a low beam is formed by diffracted light of the light. However, white light is light obtained by synthesizing pieces of light of a plurality of wavelengths. A hologram element, which is a kind of diffraction grating, has wavelength dependency. Therefore, pieces of light having different wavelengths contained in white tend to have light distribution patterns different from each other due to the hologram element. Therefore, when a low beam is applied by the vehicle headlamp described in Patent Literature 1, color blur of light occurs in which pieces of light of different colors emerge near the edge of the light distribution pattern of the low beam.

An object of the present invention is to provide a vehicle lamp that can be downsized and in which color blur of light applied can be suppressed.

To achieve the above object, a vehicle lamp of the present invention includes: a light source that emits light of a predetermined wavelength; a diffractive optical element that diffracts light emitted from the light source into a predetermined light distribution pattern; a wavelength conversion element in which light forming the light distribution pattern is projected, and that widens a wavelength band of incident light and emits the light; and a projection lens that projects the light distribution pattern projected on the wavelength conversion element.

Since this vehicle lamp can form a predetermined light distribution pattern without using a shade similarly to the vehicle headlamp described in Patent Literature 1, as similar to the vehicle headlamp of above Patent Literature 1, this vehicle lamp can be downsized as compared to a vehicle lamp using a shade. When the shade is not used, the light emitted from the light source can be effectively used. The light source of the vehicle lamp described above emits light having a predetermined wavelength. When the wavelength band of the light is narrower than that of white light, the color blur of the light diffracted by the diffractive optical element can be suppressed. Therefore, a predetermined light distribution pattern is formed by the light in which the color blur is suppressed, and the light is projected on the wavelength conversion element. In this way, the light emitted from the light source is light having a narrower wavelength band than that of white light at the time of being diffracted by the diffractive optical element, and after being diffracted by the diffractive optical element to have a predetermined light distribution pattern, the wavelength band is widened by the wavelength conversion element. Accordingly, the light forming the light distribution pattern projected by the projection lens has a wider wavelength band than that of the light emitted from the light source, and color blur can be suppressed. Therefore, the vehicle lamp described above can be a vehicle lamp that can be downsized and in which color blur of light applied can be suppressed.

It is preferable that the wavelength conversion element includes a phosphor.

When the wavelength conversion element includes a phosphor, at least some of the light emitted from the light source can be applied to the phosphor as pumping light. The pumped phosphor emits light having a wavelength different from the pumping light. Therefore, the wavelength conversion element can widen the wavelength band of the incident light and emit the light.

When the wavelength conversion element includes a phosphor, it is preferable that the wavelength conversion element emits some of the incident light without wavelength conversion.

When the wavelength conversion element is configured such that some of the light emitted from the light source is emitted without wavelength conversion, and the other part of the light is applied to the phosphor as pumping light, the wavelength conversion element emits light including light emitted from the light source and light emitted by the phosphor. Therefore, the wavelength conversion element can widen the wavelength band of the incident light and emit the light.

When the wavelength conversion element includes a phosphor, it is preferable that the wavelength conversion element includes a plurality of types of the phosphors that emit light having different wavelengths.

Since the wavelength conversion element includes a plurality of types of phosphors that emit light of different wavelengths, different types of phosphors emit light of different wavelengths when light is incident on the wavelength conversion element. Therefore, the wavelength conversion element can widen the wavelength band of the incident light and emit the light.

Furthermore, it is preferable that the wavelength conversion element transmits light incident from the diffractive optical element side to the projection lens side.

By using a transmission type wavelength conversion element as described above, even if the position and inclination of the wavelength conversion element and the entrance angle of light incident on the wavelength conversion element slightly change due to vibration or the like, the shift of the optical axis of the light emitted from the wavelength conversion element can be suppressed as compared to the reflection type wavelength conversion element. As described above, the change in the position and inclination of the wavelength conversion element and the entrance angle of the light incident on the wavelength conversion element can be allowed to some extent, so that the arrangement of the optical element such as the wavelength conversion element can be facilitated.

Furthermore, it is preferable that the wavelength conversion element reflects light incident from the diffractive optical element side to the projection lens side.

By using the reflection type wavelength conversion element as described above, the diffractive optical element and the projection lens can be arranged close to each other, so that the vehicle lamp can be further downsized. By using the reflection type wavelength conversion element, a cooling member for cooling the wavelength conversion element can be arranged on the back side of the wavelength conversion element, that is opposite to the side on which the light emitted from the light source is incident.

Furthermore, it is preferable that a Fourier transform lens is provided between the diffractive optical element and the wavelength conversion element.

By providing the Fourier transform lens between the diffractive optical element and the wavelength conversion element, an operation equivalent to the case where the distance between the diffractive optical element and the wavelength conversion element is set to infinity can occur. Accordingly, by providing the Fourier transform lens between the diffractive optical element and the wavelength conversion element, it is possible to reduce the distance between the diffractive optical element and the wavelength conversion element as compared to a case where the Fourier transform lens is not provided, so that the vehicle lamp can be further downsized.

As described above, according to the present invention, a vehicle lamp that can be downsized and in which color blur of light applied can be suppressed can be realized.

### BRIEF DESCRIPTION OF DRAWINGS

FIG. 1 is a cross-sectional view schematically showing a vehicle lamp according to a first embodiment of the present invention.

FIG. 2A and FIG. 2B are diagrams showing light distribution patterns.

FIG. 3 is a diagram showing a cross section of a vehicle lamp according to a second embodiment of the present invention, similarly to FIG. 1.

### DESCRIPTION OF EMBODIMENTS

Hereinafter, embodiments for implementing a vehicle lamp according to the present invention will be exemplified with reference to the accompanying drawings. The embodiments exemplified below are for the purpose of facilitating the understanding of the present invention, and are not intended to limit the present invention. The present invention can be modified and improved from the following embodiments without departing from the gist thereof.

### First Embodiment

First, the configuration of the vehicle lamp of the present embodiment will be described.

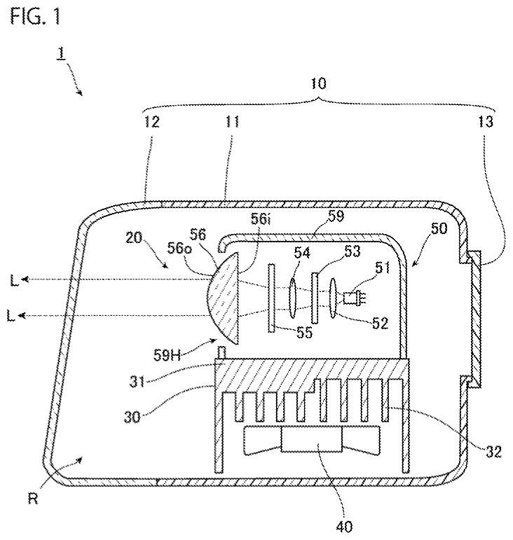

FIG. 1 is a cross-sectional view schematically showing the vehicle lamp according to the present invention. The vehicle lamp of the present embodiment is a vehicle headlamp 1 and includes a housing 10 and a lamp unit 20.

The housing 10 mainly includes a lamp housing 11, a front cover 12, and a back cover 13. The front of the lamp housing 11 is open, and a front cover 12 is fixed to the lamp housing 11 so as to close the opening. An opening smaller than the front is formed at the rear of the lamp housing 11, and the back cover 13 is fixed to the lamp housing 11 so as to close the opening.

A space formed by the lamp housing 11, the front cover 12 closing the front opening of the lamp housing 11, and the back cover 13 closing the rear opening of the lamp housing 11 is a lamp room R. The lamp unit 20 is accommodated in this lamp room R.

The lamp unit 20 includes a heat sink 30, a cooling fan 40, and an optical system unit 50 as main components. Note that the lamp unit 20 is fixed to the housing 10 by a configuration not shown.

The heat sink 30 has a metal base plate 31 extending in a substantially horizontal direction, and a plurality of heat radiation fins 32 are provided integrally with the base plate 31 on a lower surface side of the base plate 31. The cooling fan 40 is arranged with a gap from the heat radiation fin 32 and is fixed to the heat sink 30. The heat sink 30 is cooled by the airflow generated by the rotation of the cooling fan 40.

The optical system unit 50 is arranged on the upper surface of the base plate 31 of the heat sink 30. The optical system unit 50 includes a light source 51, a collimating lens 52, a diffractive optical element 53, a Fourier transform lens 54, a wavelength conversion element 55, a projection lens 56, and a cover 59.

The light source 51 of the present embodiment is a laser element that emits a laser light having a predetermined wavelength. More specifically, the light source 51 of the present embodiment emits blue laser light having a power peak wavelength of 445 nm. The optical system unit 50 has a circuit board (not shown), the light source 51 is mounted on the circuit board, and power is supplied through the circuit board.

The collimating lens 52 is a lens that collimates the fast axis direction and the slow axis direction of the laser light emitted from the light source 51. A collimating lens for collimating the fast axis direction of the laser light and a collimating lens for collimating the slow axis direction may be separately provided.

The diffractive optical element 53 diffracts the laser light emitted from the collimating lens 52 into a predetermined light distribution pattern. The diffractive optical element 53 of the present embodiment diffracts the laser light incident from the collimating lens 52 so that the light emitted from the light source 51 has a light distribution pattern of a low beam. This light distribution pattern includes a luminous intensity distribution. For this reason, the diffractive optical element 53 of the present embodiment diffracts the laser light incident from the collimating lens 52 so that the laser light emitted from the diffractive optical element 53 has a shape substantially similar to the outer shape of the light distribution pattern of the low beam L, and has a luminous intensity distribution based on the luminous intensity distribution of the light distribution pattern of the low beam L. In this way, the diffractive optical element 53 emits blue light that forms the light distribution pattern of the low beam L. However, since the low beam L is applied through the projection lens 56 as described later, the light distribution pattern formed by the diffractive optical element 53 is inverted upside down from the light distribution pattern of the low beam L applied from the vehicle headlamp 1.

The Fourier transform lens 54 is a convex lens provided between the diffractive optical element 53 and the wavelength conversion element 55. The wavelength conversion element 55 is provided at the focal position of the Fourier transform lens 54. By providing the Fourier transform lens 54 in this manner, an operation equivalent to the case where the distance between the diffractive optical element 53 and the wavelength conversion element 55 is set to infinity can occur. Accordingly, by providing the Fourier transform lens 54 between the diffractive optical element 53 and the wavelength conversion element 55, it is possible to reduce the distance between the diffractive optical element 53 and the wavelength conversion element 55 as compared to a case where the Fourier transform lens 54 is not provided, and the vehicle headlamp 1 can be further downsized.

Light forming a predetermined light distribution pattern by being diffracted by the diffractive optical element 53 is projected in the wavelength conversion element 55, and the wavelength conversion element 55 widens the wavelength band of the incident light, and emits the light. The wavelength conversion element 55 of the present embodiment includes a phosphor. When the wavelength conversion element 55 includes the phosphor, at least some of the light emitted from the light source 51 can be applied to the phosphor as pumping light. The pumped phosphor emits light having a wavelength different from the pumping light. Therefore, the wavelength conversion element 55 can widen the wavelength band of the incident light and emit the light.

Such a wavelength conversion element 55 is formed of, for example, a transparent resin sheet in which a phosphor is dispersed. In this case, the wavelength conversion element 55 transmits and emits some of the incident light without wavelength conversion. When the wavelength conversion element 55 is configured such that some of the light emitted from the light source 51 is emitted without wavelength conversion, and the other part of the light is applied to the phosphor as pumping light, the wavelength conversion element 55 emits light including light emitted from the light source 51 and light emitted by the phosphor. Therefore, the wavelength conversion element 55 can widen the wavelength band of the incident light and emit the light.

As described above, the light source 51 of the present embodiment emits blue light. Accordingly, for example, when the phosphor included in the wavelength conversion element 55 is a yellow phosphor that emits yellow light, the wavelength conversion element 55 emits blue light and yellow light. Therefore, pseudo white light is synthesized with the blue light and the yellow light.

As the phosphor included in the wavelength conversion element 55, a red phosphor that emits red light and a green phosphor that emits green light may be used in combination. In this case, the blue light transmitted through the wavelength conversion element 55, the red light emitted by the red phosphor, and the green light emitted by the green phosphor are synthesized, so that the white light with improved color rendering can be synthesized as compared to the case where the yellow phosphor is used as described above. As described above, when the wavelength conversion element 55 includes a phosphor, it is preferable that the wavelength conversion element 55 includes a plurality of types of the phosphors that emit light having different wavelengths. Since the wavelength conversion element 55 includes a plurality of types of phosphors that emit light of different wavelengths, different types of phosphors emit light of different wavelengths when light is incident on the wavelength conversion element 55. Therefore, the wavelength conversion element 55 can emit a wider wavelength band of the incident light as compared to the case where one kind of phosphor is included.

In the vehicle headlamp 1 of the present embodiment, the diffractive optical element 53, the wavelength conversion element 55, and the projection lens 56 are arranged on a straight line, and the wavelength conversion element 55 transmits light incident from the diffractive optical element 53 side to the projection lens side. By arranging the diffractive optical element 53, the wavelength conversion element 55, and the projection lens 56 on a straight line as described above, it is possible to suppress the occurrence of an optical path difference in the light forming the predetermined light distribution pattern, and to make formation of a desired light distribution pattern easy.

The projection lens 56 is an aspherical plano-convex lens, and an incident surface 56i, which is a surface on which light emitted from the light source 51 is incident, is planar, and an emission surface 56o, which is a surface on which light from the light source 51 is emitted, has a convex shape that swells toward the emitting direction of the light. Such a projection lens 56 projects a light source image formed on a rear focal plane, which is a focal plane including a rear focal point, as an inverted image. Therefore, the portion of the wavelength conversion element 55 where the light distribution pattern is projected is arranged on the rear focal plane or in the vicinity of the rear focal plane, so that the projection lens 56 can invert and project the light of the light distribution pattern projected on the wavelength conversion element 55.

The cover 59 is fixed on the base plate 31 of the heat sink 30. The cover 59 has a substantially rectangular shape, and is made of, for example, a metal such as aluminum. In a space inside the cover 59, the light source 51, the collimating lens 52, the diffractive optical element 53, the Fourier transform lens 54, the wavelength conversion element 55, and the projection lens 56 are arranged. However, an opening 59H is formed in front of the cover 59, and the emission surface 56o of the projection lens 56 is exposed at the opening 59H. Note that the inner wall of the cover 59 is preferably made light-absorbing by black alumite processing or the like. By making the inner wall of the cover 59 light-absorbing, it is possible to suppress light applied to the inner wall of the cover 59 due to unintended reflection or refraction from being reflected and emitted from the opening 59H in an unintended direction.

Next, light emission by the vehicle headlamp 1 will be described.

First, blue laser light is emitted from the light source 51 when power is supplied from a power supply (not shown). This laser light is collimated by the collimating lens 52, and then, is incident on the diffractive optical element 53. Then, the laser light incident on the diffractive optical element 53 is diffracted so as to form a predetermined light distribution pattern, and is projected on the wavelength conversion element 55 via the Fourier transform lens 54. The light applied to the wavelength conversion element 55 is emitted from the wavelength conversion element 55 after the wavelength band is widened as described above. The light emitted from the wavelength conversion element 55 is incident on the projection lens 56, passes through the projection lens 56 and the front cover 12, and is applied toward the outside of the vehicle headlamp 1. Note that the light distribution pattern of the light projected onto the wavelength conversion element 55 has a shape whose outer shape is substantially similar to and inverted upside down from the outer shape of the low beam L, and the light emitted from the projection lens 56 is the light distribution pattern of the low beam L. Since the light emitted from the diffractive optical element 53 is a luminous intensity distribution based on the luminous intensity distribution of the light distribution pattern of the low beam L as described above, the light emitted from the wavelength conversion element 55 also has the luminous intensity distribution of the low beam L.

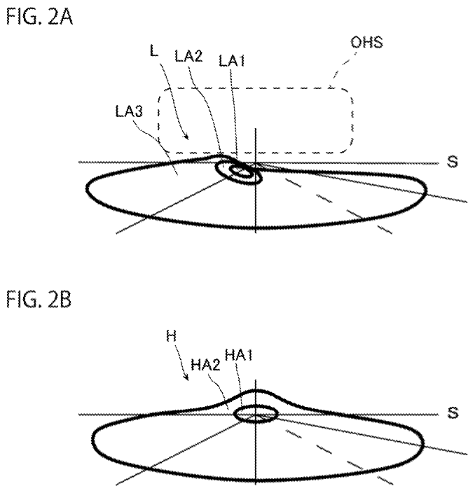

FIG. 2A and FIG. 2B are diagrams showing light distribution patterns for nighttime illumination. Specifically, FIG. 2A is a diagram showing a light distribution pattern of a low beam, and FIG. 2B is a diagram showing a light distribution pattern of a high beam. In FIG. 2A and FIG. 2B, S indicates a horizontal line, and the light distribution pattern is indicated by a thick line. In the light distribution pattern of the low beam L, which is a light distribution pattern for night illumination shown in FIG. 2A, a region LA1 is the region having the highest luminous intensity, and the luminous intensity decreases in the order of a region LA2 and a region LA3. That is, the diffractive optical element 53 diffracts the light emitted from the light source 51 so as to form a light distribution pattern including the luminous intensity distribution of the low beam L. Note that, as indicated by a broken line in FIG. 2A, light having a lower luminous intensity than the low beam L may be applied to above the position where the low beam L is applied, from the vehicle headlamp 1. This light is used as light OHS for sign recognition. In this case, it is preferable that the diffracted light emitted from the diffractive optical element 53 includes the light OHS for sign recognition. In this case, it can be understood that the low beam L and the light OHS for sign recognition form a light distribution pattern for night illumination. Note that the light distribution pattern for night illumination is not used only at night, but is also used in a dark place such as a tunnel.

As described above, the vehicle lamp 1 of the present embodiment includes: the light source 51 that emits light of a predetermined wavelength; the diffractive optical element 53 that diffracts light emitted from the light source 51 into a predetermined light distribution pattern; the wavelength conversion element 55 in which light forming the light distribution pattern is projected, and that widens a wavelength band of incident light and emits the light; and the projection lens 56 that projects the light distribution pattern projected on the wavelength conversion element 55.

Since the vehicle headlamp 1 of the present embodiment as described above can form a predetermined light distribution pattern without using a shade similarly to the vehicle headlamp described in Patent Literature 1, as similar to the vehicle headlamp described in above Patent Literature 1, this vehicle headlamp 1 can be downsized as compared with a vehicle lamp using a shade. When the shade is not used, the light emitted from the light source 51 can be effectively used.

The light source 51 of the vehicle headlamp 1 of the present embodiment emits light having a predetermined wavelength. Since the wavelength band of the light is made narrower than that of the white light, the color blur of the light diffracted by the diffractive optical element 53 can be suppressed. Therefore, a predetermined light distribution pattern is formed by the light in which the color blur is suppressed, and the light is projected on the wavelength conversion element 55. In this way, the light emitted from the light source 51 is light having a narrower wavelength band than that of white light at the time of being diffracted by the diffractive optical element 53, and after being diffracted by the diffractive optical element 53 to have a predetermined light distribution pattern, the wavelength band is widened by the wavelength conversion element 55. Accordingly, the light forming the light distribution pattern projected by the projection lens 56 has a wider wavelength band than that of the light emitted from the light source 51, and color blur can be suppressed. Therefore, the vehicle headlamp 1 of the present embodiment can be a vehicle lamp that can be downsized and in which color blur of light applied can be suppressed.

In the vehicle headlamp 1 of the present embodiment, light is simultaneously applied to regions of the wavelength conversion element 55 where light forming a predetermined light distribution pattern is projected. Accordingly, as compared to the case where the region is scanned by the light emitted from the light source, flicker of the light emitted from the wavelength conversion element can be suppressed. Furthermore, by simultaneously applying the light to the entire region, it is possible to prevent the wavelength conversion element 55 from being locally applied with high-energy light, and to suppress deterioration of the wavelength conversion element 55. Furthermore, by forming a predetermined light distribution pattern by the light diffracted by the diffractive optical element 53, a fine light distribution pattern can be easily formed as compared to the case where the light emitted from the light source is scanned to form the predetermined light distribution pattern.

Further, in the vehicle headlamp 1 of the present embodiment, the wavelength conversion element 55 transmits light incident from the diffractive optical element 53 side to the projection lens 56 side. By using a transmission type wavelength conversion element 55 in this way, even if the position and inclination of the wavelength conversion element 55 and the entrance angle of light incident on the wavelength conversion element 55 slightly change due to vibration or the like, the shift of the optical axis of the light emitted from the wavelength conversion element 55 can be suppressed as compared to a reflection type wavelength conversion element. As described above, since the change of the position and inclination of the wavelength conversion element 55 and the entrance angle of the light incident on the wavelength conversion element 55 can be allowed to some extent, the arrangement of the optical element such as the wavelength conversion element 55 can be facilitated.

### Second Embodiment

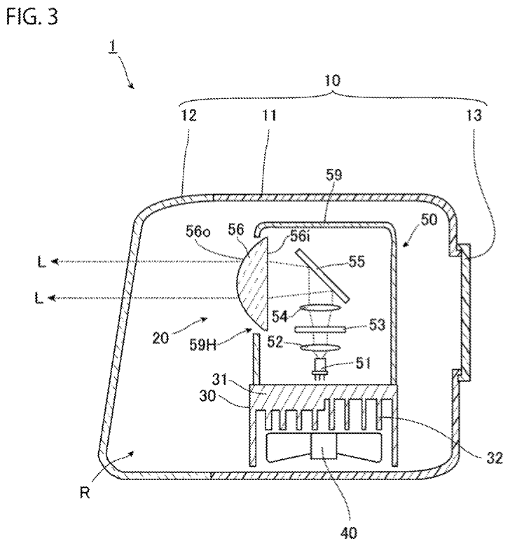

Next, a second embodiment of the present invention will be described in detail with reference to FIG. 3. Note that the same or equivalent constituent elements as those of the first embodiment are denoted by the same reference numerals, and redundant explanation will be omitted except when particularly described.

FIG. 3 is a diagram showing a cross section of a vehicle lamp according to the present embodiment, similarly to FIG. 1. As shown in FIG. 3, the optical system unit 50 in the vehicle headlamp 1 of the present embodiment is different from the optical system unit 50 of the first embodiment in that the diffractive optical element 53, the wavelength conversion element 55, and the projection lens 56 are arranged on a non-straight line, and the wavelength conversion element 55 reflects light incident from the diffractive optical element 53 side to the projection lens 56 side.

In the present embodiment, by using the reflection type wavelength conversion element 55 as described above, the diffractive optical element 53 and the projection lens 56 can be arranged close to each other, so that the vehicle headlamp 1 can be further downsized. By using the reflection type wavelength conversion element 55, a cooling member (not shown) for cooling the wavelength conversion element 55 can be arranged on the back side of the wavelength conversion element 55, that is opposite to the side on which the light emitted from the light source 51 is incident.

Also in the present embodiment, similarly to the first embodiment, the diffractive optical element 53 diffracts light so that the light emitted from the light source 51 forms a light distribution pattern of the low beam L. Note that, also in the present embodiment, as shown by a broken line in FIG. 2A, light OHS for sign recognition may be emitted. In this case, as similar to the first embodiment, it is preferable that the diffracted light emitted from the diffractive optical element 53 includes the light OHS for sign recognition.

Although the present invention has been described above with the embodiments as examples, the present invention is not limited to these.

For example, in the above embodiment, the vehicle headlamp 1 that emits the low beam L has been described as an example. However, the vehicle lamp of the present invention may emit a high beam H. In that case, the light of the light distribution pattern of the high beam H, which is the light distribution pattern for night illumination shown in FIG. 2B, is applied. Note that, in the light distribution pattern of the high beam H in FIG. 2B, the region HA1 is a region having the highest luminous intensity, and the region HA2 is a region having a lower luminous intensity than the region HA1. That is, the diffractive optical element 53 diffracts the light so that the light emitted from the light source 51 forms a light distribution pattern including the luminous intensity distribution of the high beam H.

In the above embodiment, an example has been described in which the light distribution pattern formed by forming an image of the diffracted light formed by the diffractive optical element 53 is one predetermined light distribution pattern. However, the diffractive optical element 53 may be capable of freely changing the light distribution pattern formed by the diffracted light. For example, the diffractive optical element 53 can include a Si substrate having on the surface a plurality of pixel electrodes whose potentials are independently controlled, a transparent electrode, and a liquid crystal layer sandwiched between the pixel electrode and the transparent electrode. In this case, the light distribution pattern formed by forming an image of the diffracted light formed by the diffractive optical element 53 can be freely changed by independently controlling the potentials of the plurality of pixel electrodes.

In the above embodiment, the case where the light source 51 emits blue light has been described as an example. However, in the vehicle lamp of the present invention, the wavelength of the light emitted from the light source 51 is not limited. For example, the light source 51 may emit near-ultraviolet light. In this case, it is preferable that, for the wavelength conversion element 55, a red phosphor that emits red light, a green phosphor that emits green light, and a blue phosphor that emits blue light are used in combination. With the light source 51 and the wavelength conversion element 55 configured as described above, red light, green light, and blue light are emitted from the wavelength conversion element 55, and white light having high color rendering can be synthesized.

In the above embodiment, the optical system unit 50 including the Fourier transform lens 54 has been described as an example. However, the optical system unit 50 may not include the Fourier transform lens 54. In this case, light emitted from the diffractive optical element 53 is directly incident on the wavelength conversion element 55. With such a configuration, an increase in the number of components can be suppressed.

The vehicle lamp of the present invention is not limited to a vehicle headlamp, and may be, for example, a drawing lamp for displaying characters, figures, and the like outside a vehicle.

According to the present invention, a vehicle lamp that can be downsized and in which the color blur of light applied can be suppressed is provided, and can be utilized in the field of vehicle headlamps of an automobile or the like.

### REFERENCE SIGNS LIST

1 vehicle headlamp
10 housing
20 lamp unit
30 heat sink
40 cooling fan
51 light source
53 diffractive optical element
54 Fourier transform lens
55 wavelength conversion element
56 projection lens

1. A vehicle lamp comprising:
a light source that emits light of a predetermined wavelength;
a diffractive optical element that diffracts light emitted from the light source into a predetermined light distribution pattern;
a wavelength conversion element in which light forming the light distribution pattern is projected, and that widens a wavelength band of incident light and emits the light; and
a projection lens that projects the light distribution pattern projected on the wavelength conversion element.

2. The vehicle lamp according to claim 1, wherein
the wavelength conversion element includes a phosphor.

3. The vehicle lamp according to claim 2, wherein
the wavelength conversion element emits some of incident light without wavelength conversion.

4. The vehicle lamp according to claim 2, wherein
the wavelength conversion element includes a plurality of types of the phosphors that emit light having different wavelengths.

5. The vehicle lamp according to claim 1, wherein
the wavelength conversion element transmits light incident from a side of the diffractive optical element to a side of the projection lens.

6. The vehicle lamp according to claim 1, wherein
the wavelength conversion element reflects light incident from a side of the diffractive optical element to a side of the projection lens.

7. The vehicle lamp according to claim 1, wherein
a Fourier transform lens is provided between the diffractive optical element and the wavelength conversion element.
